(19) United States
(12) Patent Application Publication
(10) Pub. No.: US 2015/0112812 A1
(43) Pub. Date: Apr. 23, 2015

(54) METHOD AND APPARATUS FOR INFERRING USER DEMOGRAPHICS

(71) Applicant: THOMSON LICENSING, Issy de Moulineaux (FR)

(72) Inventors: Udi Weinsberg, Menlo Park, CA (US); Smriti Bhagat, San Francisco, CA (US); Stratis Ioannidis, San Francisco, CA (US); Nina Taft, San Francisco, CA (US)

(21) Appl. No.: 14/407,114

(22) PCT Filed: Jun. 10, 2013
(86) PCT No.: PCT/US13/44880

§ 371 Date: Dec. 11, 2014

Related U.S. Application Data
(60) Provisional application No. 61/662,609, filed on Jun. 21, 2012.

(51) Int. Cl. G06Q 30/02

(52) U.S. Cl. CPC G06Q 30/0269
USPC 705/14.66

(57) ABSTRACT

A method to determine demographic information of a new user utilizing only ratings includes training an inference engine informed with a training data set which includes ratings and demographic information from a plurality of other users. The new user inputs ratings, such as movie ratings, and an inference engine determines demographic information of the new user. The demographic information of the new user can then be used to provide recommendations or to provide targeted advertisements to the new user.

### CROSS REFERENCE TO RELATED APPLICATION

This application claims priority to U.S. Provisional Application No. 61/662,609 entitled “Method and Apparatus For Inferring User Demographics Based on Ratings”, filed on 21 Jun. 2012, which is hereby incorporated by reference in its entirety for all purposes.

### FIELD

The present invention relates generally to user profiling and user privacy in recommender systems. More specifically, the invention relates to demographic information inference.

### BACKGROUND

Inferring demographics of users has been studied in different contexts, and for various types of user generated data. In the context of interaction networks, the graph structure has been shown to be useful for inferring demographics using link based information for blog and social network data from Facebook. Other works rely on the textual features derived from writings of users to infer demographics.

The major disadvantage of text-based inference is that most users do not provide written reviews, thus these methods are not applicable. Similarly, recommender systems might not get hold of the social network of the user they want to infer details about.

It can be seen that a user demographics inference method based on as little as information as possible is desired. This invention is directed to such an inference method.

### SUMMARY

This summary is provided to introduce a selection of concepts in a simplified form that are further described below in the Detailed Description. The Summary is not intended to identify key features or essential features of the claimed subject matter, nor is it intended to be used to limit the scope of the claimed subject matter.

The present invention includes a method and apparatus to determine demographic information of a new user utilizing her movie ratings. The method includes training an inference engine to determine demographic information using a training data set which includes movie ratings and demographic information from a plurality of other users. Then, movie ratings from the new user are received where the movie ratings from the particular user are received are without demographic information. The demographic information of the new user is determined using the trained inference engine. The inference engine may be part of a recommender system that utilizes the determined demographic information to provide recommendations to the new user or to provide targeted advertisements to the new user.

Additional features and advantages of the invention will be made apparent from the following detailed description of illustrative embodiments which proceeds with reference to the accompanying figures.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 illustrates an exemplary environment embodiment for an inference engine according to aspects of the invention;

FIG. 2a depicts a Receiver Operating Characteristic (ROC) plot of different classifiers for a Flixster training data set;

FIG. 2b depicts a Receiver Operating Characteristic (ROC) plot of different classifiers for a Movielens training data set;

FIG. 2c depicts the increase of precision according to size for a Flixster training data set;

FIG. 3 illustrates an example flow diagram of a use according to aspects of the invention; and

FIG. 4 illustrates an example inference engine according to aspects of the invention.

### DETAILED DISCUSSION OF THE EMBODIMENTS

In the following description of various illustrative embodiments, reference is made to the accompanying drawings, which form a part thereof, and in which is shown, by way of illustration, various embodiments in the invention may be practiced. It is to be understood that other embodiments may be utilized and structural and functional modification may be made without departing from the scope of the present invention.

Profiling users through demographic information, such as gender, age, income, or ethnicity, is of great importance in targeted advertising and personalized content delivery. Recommender systems too can benefit from such information to provide personalized recommendations. However, users of recommender systems often do not volunteer this information. This may be intentional to protect their privacy, or unintentional—out of laziness or disinterest. As such, traditional collaborative filtering methods, which extract meaningful information from patterns that emerge from collecting users' ratings from multiple users, eschew using such information, relying instead solely on ratings provided by users.

At a first glance, disclosing ratings to a recommender system may appear as a rather innocuous action. There is certainly a utility that users accrue from this disclosure—namely, the ability to discover relevant content items. Nevertheless, there has been a fair amount of work indicating that user demographics are correlated to, and thus can be inferred from, user activity on social networks, blogs, and microblogs etc. It is thus natural to ask whether demographic information such as age, gender, ethnicity or even political orientation can also be inferred from information disclosed to collaborative filtering systems. Indeed, irrespective of a rating value, the mere fact that a user has interacted with an item (e.g., viewed a specific movie, listened to a specific song, or purchased a product) may be correlated with demographic information.

The potential success of such an inference has several important implications. On one hand, from the recommender's perspective, profiling users with respect to demographic information opens the way to several applications; beyond recommendations, such profiling can generate additional revenue through advertising, as advertisers are primarily interested in targeting specific demographic groups. The present invention is directed towards such inferring techniques. It is assumed that the information users wish to infer is their gender; nevertheless, the methods of the invention also apply when different demographic features (age, ethnicity, political orientation, etc.) are to be inferred. Also, although specific embodiments are directed to ratings on movies, this is only one example. Ratings of any type may be used, including but not limed to ratings on songs, digital games, products, restaurants, and the like. For simplicity and clarity of understanding, the example of using movie ratings to determine demographic information is primarily used, but other types of ratings are also applicable.

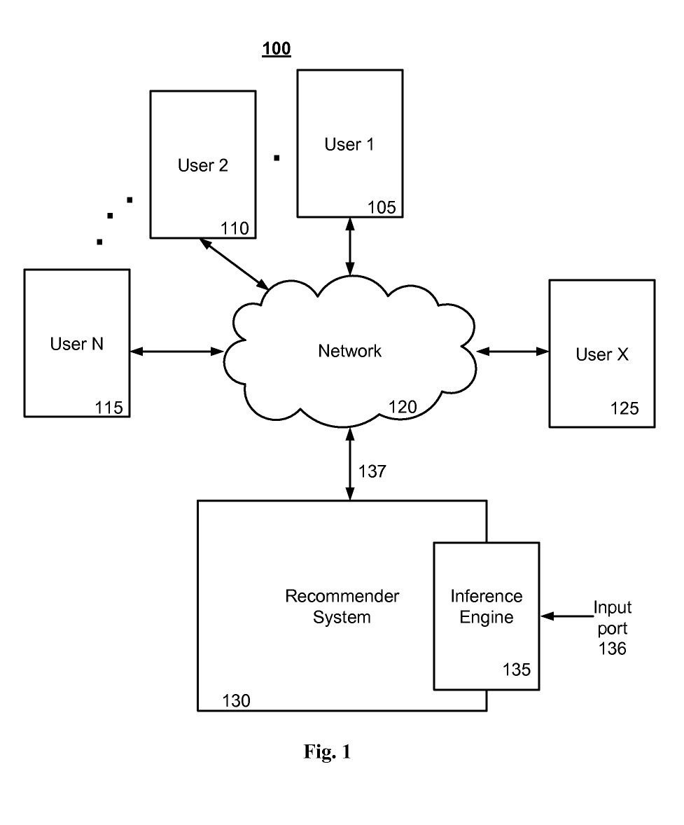

FIG. 1 depicts an exemplary system 100 or environment for an inference engine as discussed in herein. Other environments are possible. The system 100 of FIG. 1 depicts a recommender system 130 which provides content recommendations to users on a network 120. Typical examples of the recommender system include content recommender systems which are operated by content providers such as Netflix®, Hulu®, Amazon®, and the like. Normally, a recommender system 100 provides candidate digital content for subscribing users. Such content can include streaming video, DVD mailings, books, articles, and merchandise. In one example instance of streaming video, candidate movies can be recommended to a user based on her past movie selection or select user profile characteristics. As one example embodiment, the instance of streaming video is considered.

In the current invention context, the inference engine 135 can be a data processing device that can infer demographic information from non-demographic information provided by a user 125 who sends movie ratings to the recommender system 130. The inference engine 135 functions to process the movie ratings provided by user 125 and infer demographic information. In one example instance, the demographic information discussed is gender. But one of skill in the art will recognize that other demographic information may also be inferred according to aspects of the invention. Such demographic information may include, but is not limited to, age, ethnicity, political orientation, and the like.

According to an aspect of the invention, as described below, the inference engine 135 operates using training data acquired via users 1, 2 to n (105, 110 to 115 respectively). These users provide movie rating data as well as demographic information to the inference engine 135 via the recommender system 130. The training data set may be acquired over time as users 105 through 115 use the recommender system. Alternately, the inference engine can input a training data set in one or more data loads directly imported via an input port 136. Port 136 may be used to input a training data set from a network, a disk drive, or other data source containing the training data.

Inference engine 135 utilizes algorithms to process the training data set. The inference engine 135 subsequently utilizes user 125 (user X) inputs containing movie ratings. Movie ratings contain one or more of movie identification information, such as movie title or movie index or reference number and a rating value to infer demographic information concerning user 125. A “movie title”, or more generically “movie identifier” as used in this discussion, is an identifier, such as a name or title or a database index of the movie, show, documentary, series episode, digital game, or other digital content viewed by user 125. A rating value is a subjective measure of the viewed digital content as judged by user 125. Normally, rating values are quality assessments made by the user 125 and are graded on a scale from 1 to 5; 1 being a low subjective score and 5 being a high subjective score. Those of skill in the art will recognize that other may equivalently be used such as a 1 to 10 numeric scale, an alphabetical scale, a five star scale, a ten half star scale, or a word scales ranging from “bad” to “excellent”. Note that according to aspects of the invention, the information provided by user 125 does not contain demographic information and the inference engine 135 determines the user 125's demographic information from only her movie ratings.

According to an aspect of the invention, a training data set is used to teach the inference engine 135. The training data set may be available to both the recommended system 130 as well as the inference engine 135. A characterization of the training data set is now provided. The training dataset comprises a set of [symbol] ={1, . . . , N} users each of which has given ratings to a subset of the movies in the catalog [symbol] . Denoted by [symbol] ᵢ [symbol] [symbol] is the set of movies for which the rating of a user i ε z,z,22 is in the dataset, and by rᵢⱼ, j ε [symbol] ᵢ, the rating given by user i ε [symbol] to movie j ε [symbol] . Moreover, for each i ε [symbol] the training set also contains a binary variable yᵢ ε {0,1} indicating the gender of the user (bit 0 is mapped to male users). The training data set is assumed unadulterated: neither ratings nor gender labels have been tampered with or obfuscated.

The recommender mechanism throughout the paper is assumed to be matrix factorization since this is commonly used in commercial systems. Although matrix factorization is utilized as an example, any recommender mechanism may be used. Alternate recommender mechanisms include the neighborhood method (clustering of users), contextual similarity of items, or other mechanism known to those of skill in the art. Ratings for the set [symbol] \M \ [symbol] ₀ are generated by appending the provided ratings to the rating matrix of the training set and factorizing it. More specifically, we associate with each user i ε [symbol] ∪ {0} a latent feature vector μᵢ ε [symbol] ^{d}. Associated with each movie j ε [symbol] is a latent feature vector vⱼ ε [symbol] ^{d}. The regularized mean square error is defined to be

$${\sum }_{i ∈ 𝒩 ⋃ \{ 0 \} , j ∈ {𝒮}_{i}} {( {r}_{i , j} - 〈 {u}_{i} , {v}_{j} 〉 - μ )}^{2} + λ {\sum }_{i ∈ 𝒩 ⋃ \{ 0 \}} {‖ {u}_{i} ‖}_{2}^{2} + λ {\sum }_{j ∈ ℳ} {‖ {v}_{j} ‖}_{2}^{2}$$

where μ is the average rating of the entire dataset. The vectors uᵢ, vⱼ are constructed by minimizing the MSE through gradient descent. Values of d=20 and λ=0.3 are used. Having profiled thusly both users and movies, the rating of user 0 is predicted for movie j ε [symbol] \ [symbol] ₀′ through <u₀, vⱼ>+μ.

Two example training datasets are considered; Flixster and Movielens. Flixster is a publicly available online social network for rating and reviewing movies. Flixster allows users to enter demographic information into their profiles and share their movie ratings and reviews with their friends and the public. The dataset has 1 M users, of which only 34.2K users share their age and gender. This subset of 34.2K users is considered, who have rated 17K movies and provided 5.8 M ratings. The 12.8K males and 21.4K females have provided 2.4 M and 3.4 M ratings, respectively. Flixster allows users to provide half star ratings, however, to be consistent across the evaluation datasets, the ratings are rounded up to be integers from 1 to 5. Another data set is Movielens. This second dataset is publicly available from the Grouplens™ research team. The dataset consists of 3.7K movies and 1 M ratings by 6K users. The 4331 males and 1709 females provided 750K and 250K ratings, respectively.

To determine demographic information, classifiers are used in the inference engine. As expressed above, demographic information can include many characteristics. The determination of gender as an example demographic is expressed as one embodiment in the current invention. However, the determination of different or multiple demographic characteristics of a user is within the scope of the present invention.

To train classifiers, they are associated with each user i ε [symbol] in the training set a characteristic vector xᵢ ε [symbol] ^{M} such that xᵢⱼ=rᵢⱼ, if j ε [symbol] ᵢ and xᵢⱼ=0, otherwise. Recall that the binary variable yᵢ indicates user i's gender, which serves as the dependent variable in classification. Denote by X ε [symbol] ^{N×M} is the matrix of characteristic vectors, and by Y ε {0,1}^{N} the vector of genders.

Three different types of classifiers are examined: Bayesian classifiers, support vector machines (SVM), and logistic regression. In the Bayesian setting, several different generative models are examined; for all models, assume that points (xᵢ, yᵢ) are sampled independently from the same joint distribution P(x, y). Given P, the predicted label ŷ ε {0,1} attributed to characteristic vector x is the one with maximum likelihood, i.e.,

ŷ=arg max_{yε{0,1}}P(y|x)=arg max_{yε{0,1}}P(x,y) (1)

The class prior classification is now described. The class prior classification serves as a base-line method for assessing the performance of the other classifiers. Given a dataset with unevenly distributed gender classes of the population, this basic classification strategy is to classify all users as having the dominant gender. This is equivalent to using equation (1) under the generative model P (y|x)=P (y), estimated from the training set as:

P(y)=|{iε [symbol] :yᵢ=y}|/N. (2)

The Bernoulli Nave Bayes is classification is now described. Bernoulli Naïve Bayes is a simple method that ignores the actual rating value. In particular, it assumes that a user rates movies independently and the decision to rate or not is a Bernoulli random variable. Formally, given a characteristic vector x, we define the rating indicator vector \tilde{x} ε [symbol] ^{M} to be such that \tilde{x}ⱼ=1ₓ_{ⱼ}_{>0}. This captures the movies for which a rating is provided. Assuming that \tilde{x}ⱼ, j ε z,23 , are independent Bernoulli, the generative model is given by P(x,y)=P(y)π_{jε} [symbol] P(\tilde{x}ⱼ|y) where P(y) is the class prior, as in equation (2), and the conditional P(\tilde{x}ⱼ|y) is computed from the training set as follows:

P(\tilde{x}ⱼ|y)=|{iε [symbol] :\tilde{x}ᵢⱼ=\tilde{x}ⱼΛyᵢ=y}|/|{i:yᵢ=y}| (3)

The Multinomial Naïve Bayes classification is now described. A drawback of Bernoulli Naïve Bayes is that it ignores rating values. One way of incorporating them is through Multinomial Naïve Bayes, which is often applied to document classification tasks. Intuitively, this method extends Bernoulli to positive integer values by treating, e.g. a five-star rating as 5 independent occurrences of the Bernoulli random variable. Movies that receive high ratings have thus a larger impact on the classification. Formally, the generative model is given by P(x,y)=P(y)π_{jε} [symbol] P(xⱼ|y) where P (xⱼ|y)=P(\tilde{x}ⱼ|y)^{x}^{ⱼ}, and P(\tilde{x}ⱼ|y) is computed from the training set through equation (3).

A mixed Naïve Bayes is now described according to an aspect of the invention. An alternative to above-described Multinomial, which the inventors refer to as Mixed Naïve Bayes. This model is based on the assumption that, users give normally distributed ratings. More specifically,

P(xⱼ|\tilde{x}ⱼ=1,y)=(2πσ_{y}²)^{-1/2}e^{-(x}^{ⱼ}^{-μ}^{_{yj}}⁾^{²}^{/2σ}^{_{y}}², (4)

For each movie j, an estimate of the mean μ_{yi} is from the dataset as the average rating of movie j given by users of gender y, and the variance σ_{y}² is estimated as the variance of all ratings given by users of gender y. The joint likelihood used in equation (1) is then given by P(x,y)=P(y)π_{jε} [symbol] P(\tilde{x}ⱼ|y)P(xⱼ|\tilde{x}ⱼ,y) where P(y), P(\tilde{x}ⱼ|y) are estimated through equations (2) and (3), respectively. The conditional P(xⱼ|\tilde{x}ⱼ,y) is given by equation (4) when a rating is provided (i.e., \tilde{x}ⱼ=1) and, trivially, by P(xⱼ=0|\tilde{x}ⱼ=0,y)=1, when it is not.

The use of logistic regression in the current invention is now described. A significant drawback of all of the above Bayesian methods is that they assume that movie ratings are independent. To address that, the inventors applied logistic regression. Recall that linear regression yields a set of coefficients β={β₀,β₁, . . . ,β_{M}}. The classification of a user i ε N with characteristic vector xᵢ is performed by first calculating the probability pᵢ=(1+e^{-(β}^{₀}^{+β}^{₁}^{x}^{ᵢ₁}^{+ . . . +β}^{_{M}}^{x}^{_{iM}}⁾)⁻¹. The user is classified as a female if pᵢ<0.5 and as a male otherwise. The value pᵢ also serves a confidence value for the classification of user i. One of great benefits of using logistic regression is that the coefficients β capture the extent of the correlation between each movie and the class. In the current instance, the large positive βⱼ indicates that movie j is correlated with class male, whereas small negative βⱼ indicates that movie j is correlated with class female. We select the regularization parameter so that we have at least 1000 movies correlated with each gender that have a non-zero coefficient.

In machine learning, support vector machines (SVM) are supervised learning models with associated learning algorithms that analyze data and recognize patterns, and are used for classification and regression analysis. Intuitively, an SVM finds a hyperplane that separates users belonging to different genders in a way that minimizes the distance of incorrectly classified users from the hyperplane as is well known in the art. An SVM holds many of the advantages of logistic regression; it does not assume independence in the feature space and produces coefficients. Since the feature space (number of movies) is already quite large, linear SVMs are used in the classifier evaluations. Performing a logarithmic search over the parameter space (C), the inventors find that C=1 gave the best results.

TABLE 1
Mean AUC, precision (P) and recall (R)

| | Flixster | | Movielens | |
|---|---|---|---|---|
| | AUC | P/R | AUC | P/R |
| Class Prior | 0.50 | 0.39/0.62 | 0.50 | 0.51/0.72 |
| Bernoulli | 0.72 | 0.70/0.70 | 0.81 | 0.79/0.76 |
| Multinomial | 0.75 | 0.71/0.71 | 0.84 | 0.80/0.76 |
| Mixed | 0.74 | 0.71/0.71 | 0.82 | 0.79/0.77 |
| SVM | 0.82 | 0.73/0.70 | .86 | 0.78/0.77 |
| SVM (\tilde{X}) | 0.80 | 0.72/0.70 | 0.85 | 0.78/0.77 |
| Logistic | .84 | 0.76/0.77 | 0.85 | 0.80/0.80 |
| Logistic (\tilde{X}) | 0.83 | 0.75/0.76 | 0.84 | 0.78/0.79 |

TABLE 2
Per-gender precision and recall.

| | Flixster | | Movielens | |
|---|---|---|---|---|
| | Female | Male | Female | Male |
| Class Prior | 0.62/1 | 0/0 | 0/0 | 0.72/1 |
| Bernoulli | 0.75/0.80 | 0.62/0.54 | 0.57/0.73 | 0.88/0.78 |
| Multinomial | 0.76/0.78 | 0.63/0.60 | 0.57/0.73 | 0.89/0.77 |
| Mixed | 0.76/0.81 | 0.64/0.57 | 0.57/0.74 | 0.88/0.78 |
| SVM | 0.70/0.95 | 0.77/0.30 | 0.80/0.28 | 0.78/0.97 |
| SVM (\tilde{X}) | 0.69/0.96 | 0.77/0.27 | 0.80/0.28 | 0.77/0.97 |
| Logistic | 0.79/0.85 | 0.71/0.62 | 0.69/0.56 | 0.84/0.90 |
| Logistic (\tilde{X}) | 0.77/0.87 | 0.72/0.57 | 0.73/0.40 | 0.80/0.94 |

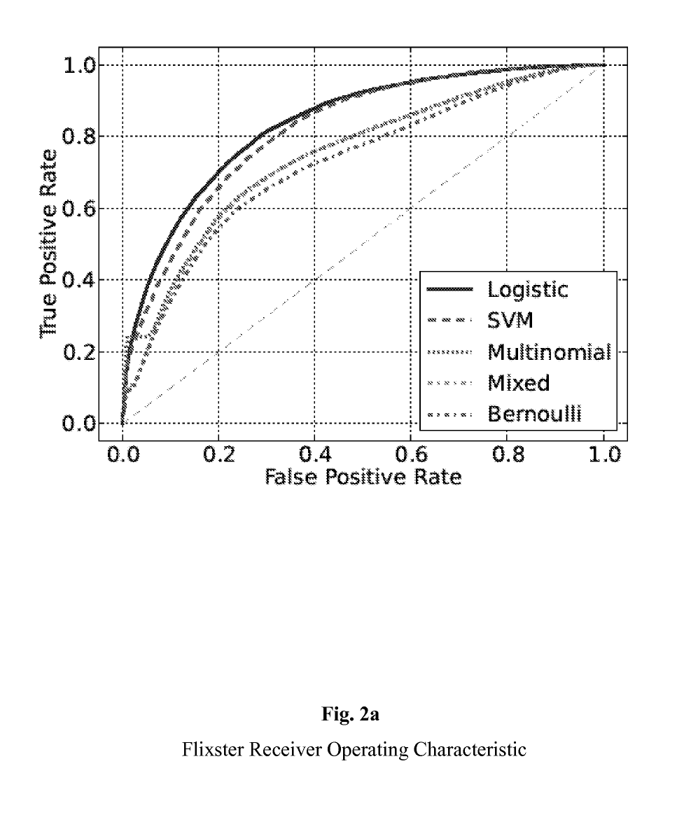

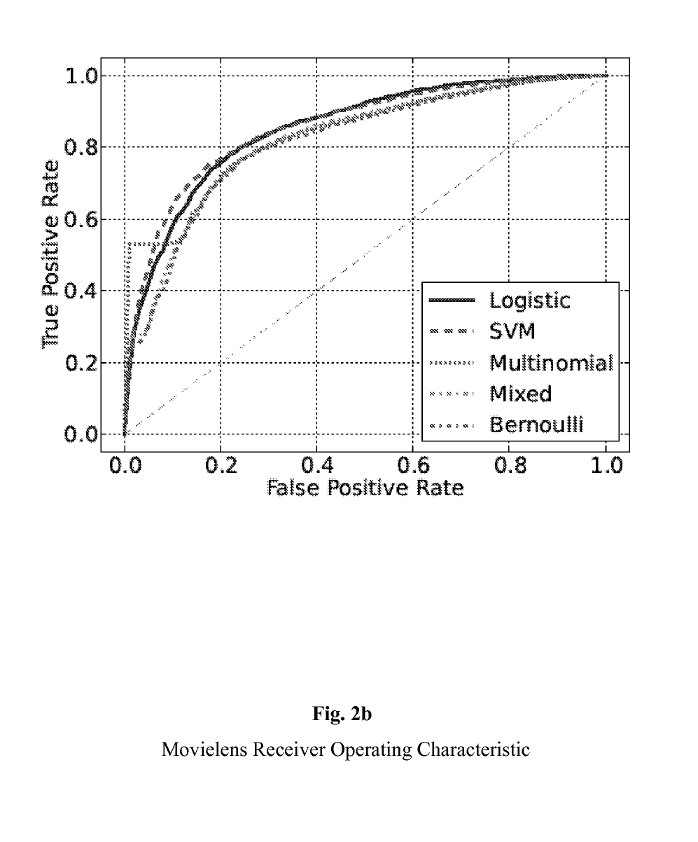

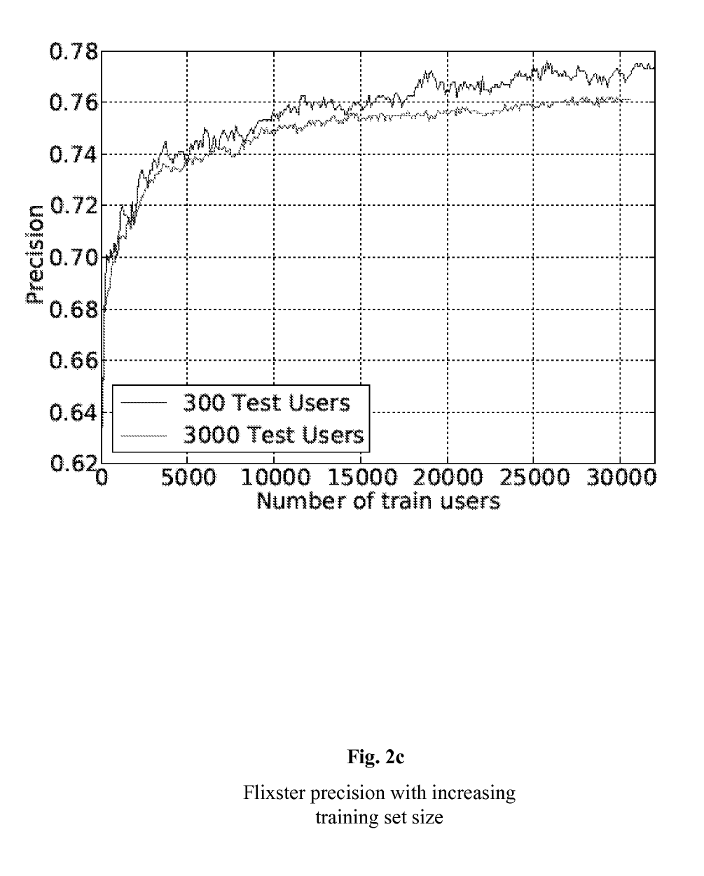

All algorithms were evaluated on both the Flixster and Movielens datasets. 10-fold cross validation was used and the average precision and recall were computed for the two the mean Receiver Operating Characteristic (ROC) curve computed across the folds. For the ROC, the true positive ratio is computed as the ratio of males correctly classified out of the males in the dataset, and the false positive ratio is computed as the ratio incorrectly classified males out of the females in the dataset. Table 1 provides a summary of the classification results for 3 metrics: AUC, precision and recall. Table 2 shows the same results separated per-gender. The ROC curves are given in FIG. 2(a) and FIG. 2(b). Table 1 provides a summary of the classification results for 3 metrics: AUC, precision and recall. Table 2 shows the same results separated per-gender.

As seen from the ROC curves, the SVM and logistic regression perform better, across both datasets, than any of the Bayesian models since the regression curves for SVM and logistic dominate the others. In particular, logistic regression performed the best for Flixster while SVM performed best for Movielens. The performance of the Bernoulli, mixed, and multinomial models do not different significantly from one another. These findings are further confirmed via the AUC values in Table 1. This table also shows the weakness of the simple class prior model that is easily outperformed by all other methods.

In general, precision in a classification task is the number of true positives (i.e. the number of items correctly labeled as belonging to the positive class) divided by the total number of elements labeled as belonging to the positive class (i.e. the sum of true positives and false positives, which are items incorrectly labeled as belonging to the class). Recall in this context is defined as the number of true positives divided by the total number of elements that actually belong to the positive class (i.e. the sum of true positives and false negatives, which are items which were not labeled as belonging to the positive class but should have been).

In terms of precision and recall, Table 2 shows that logistic regression outperforms all other models for Flixster users and both genders. For the Movielens users, SVM performs better than all other algorithms, while logistic regression is second best. In general, the inference performs better for the gender that is dominant in each dataset (female in Flixster and male in Movielens). This is especially evident for SVM, which exhibits very high recall for the dominate class and low recall for the dominated class. The mixed model improves significantly on the Bernoulli model and results similarly to the multinomial. This indicates that the usage of a Gaussian distribution might not be a sufficiently accurate estimation for the distribution of the ratings.

The impact of user ratings with respect to the rating value itself (number of stars or other subjective scale) versus the simple binary event “watched or not” is assessed by applying logistic regression and SVM on a binary matrix, denoted by \tilde{X}, in which ratings are replaced by 1. Table 1 shows the performance of these two methods on X and \tilde{X}. Interestingly, SVM and logistic regression performed only slightly better when using X rather than X as input, with less than 2% improvement on all measures. In fact, Table 2 indicates that although using X performs better than using \tilde{X} for the dominant class, it is worse for the dominated class. Similarly, the Bernoulli model, which also ignores the rating values, performed relatively close to Multinomial and Mixed. This implies that whether or not a movie is included in one's profile is nearly as impactful as the value of star rating given for the movie.

The effect of the training set size was evaluated. Since 10-fold cross validation was used, the training set is large relative to the evaluation set. The Flixster data is used to assess the effect that the number of users in the training set size has on the inference accuracy. In addition to the 10-fold cross validation giving 3000 users in the evaluation set, a 100-fold cross validation was performed using a 300-user evaluation set. Additionally, incrementally increasing the training set, starting from 100 users and adding 100 more users on each iteration was performed.

FIG. 2(c) plots the precision of the logistic regression inference on Flixster for the two evaluation set sizes. The figure shows that for both sizes, roughly 300 users in the training set are sufficient for the algorithm to reach above 70% precision, while 5000 users in the training set reaches a precision above 74%. This indicates that a relatively small number of users are sufficient for training.

The movie-gender correlation was considered. The coefficients computed by logistic regression expose movies that are most correlated with males and females. Table 3 lists the top 10 movies correlated with each gender for Flixster; similar observations as the ones below hold for Movielens. The movies are ordered based on their average rank across the 10-folds. Average rank was used since the coefficients can vary significantly between folds, but the order of movies does not. The top gender correlated movies are quite different depending on whether X or \tilde{X} is used as input. For example, out of the top 100 most female and male correlated movies, only 35 are the same for males across the two inputs, and 27 are the same for females; the comparison yielded a Jaccard distance of 0.19 and 0.16, respectively. Many of the movies in both datasets align with the stereotype that action and horror movies are more correlated with males, while drama and romance are more correlated with females. However, gender inference is not straightforward because the majority of popular movies are well liked by both genders.

Table 3 shows that in both datasets some of the top male correlated movies have plots that involve gay males, (such as Latter Days, Beautiful Thing, and Eating Out); we observed the same results when using \tilde{X}. The main reason for this is that all of these movies have a relatively small number of ratings, ranging from a few tens to a few hundreds. In this case it is sufficient for a small variance in the rating distributions between genders with respect to the class priors, to make the movie highly correlated with the class.

TABLE 3
Top male and female correlated
movies in Flixster

| Female | Male |
|---|---|
| Broken Bridges | Latter Days |
| Something the Lord Made | Beautiful Thing |
| Drunken Master | Birth |
| Dracula-Dead and Loving It | Eating Out |
| Young Indiana Jones | Prince of Darkness |
| Pootie Tang | Mimic |
| Anne of Green Gables | Show Girls |
| Another Cinderella Story | Godzilla: Final Wars |
| The Fox and the Hound 2 | Studio 54 |
| Winnie the Pooh | Desperately Seeking Susan |

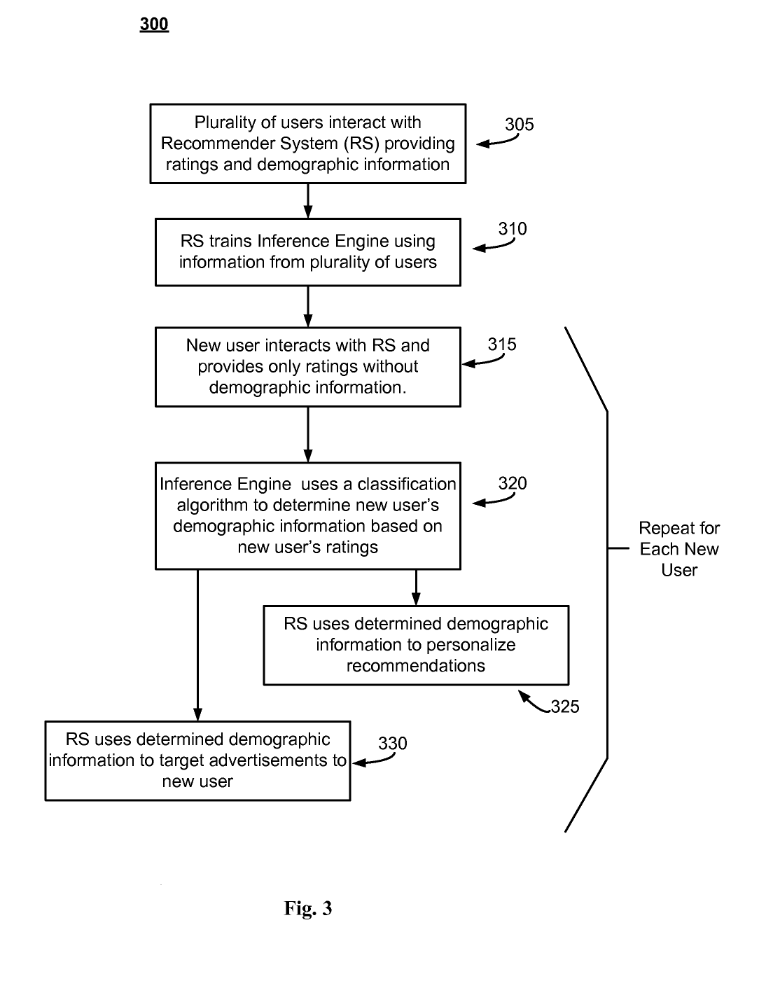

Having fully characterized the SVM and linear regression classifiers on the two available data sets, and having favorable results, a novel method and apparatus is invented to realize an inference engine. FIG. 3 represents a method according to aspects of the invention to generate demographic information from user ratings which do not have demographic information and to utilize those results for useful purposes. The end purposes of using such generated demographic information include the targeting of advertisements to the user 125, and/or to provide enhanced recommendations via a recommender system 130.

The method 300 of FIG. 3 begins with an input of a training data set having rating and demographic information representing a plurality of users into an inference engine at step 305. FIG. 1 illustrated the inference engine 135 to be part of a recommended system 130. This step may be accomplished using the recommended system connection 137 to the network 120 or may be accomplished via direct input to the inference engine 135 via port 136. If the input is via the recommended system network connection 137, then the training data set may be a one-by-one accumulation of demographic and rating information (movie ratings or any other digital content ratings), or one or more loads of at least one user training data sets having demographic and rating information. If the input is via input port 136 to the inference engine 135 directly, then the data is one or more downloads of at least one user training data set. At step 210, the recommender system 135 trains the inference engine using the information from the training data set. Step 210 can be skipped if the inference engine 135 has a direct download via port 136. In either event, steps 205 and 210 represent a training of the inference engine 135 with a training data set having both user demographic information as well as user rating information.

At step 315, a new user that is not in the training data set, such as user 125, interacts with the recommender system 130 and provides only ratings. As described above, these ratings can be, for example, movie ratings having movie identifier information and subjective rating value information. The ratings provided by user 125 are without demographic information that is sought by the inference engine. After the new user 125 inputs her ratings into the recommender system, then, at step 320 the inference engine 135 uses a classification algorithm to determine the new user's demographic information based on the new user's ratings. The classification algorithm is preferably one of support vector machines (SVM), or logistic regression as discussed earlier.

Having determined the new user's demographic information, the determined demographic information, such as gender, may be used for many useful purposes. Two examples are provided in FIG. 3. In one example, the demographic information determined at step 320 is used at step 325 by the recommender system 130 to provide enhanced recommendations to the new user. For example, if the recommender system 130 is a movie recommender system, such as operated by Netflix™ or Hulu™, then the demographic information, such as gender, may be used to more closely select gender-specific movies for the new user to view. Alternately, the recommender system 130 can use the determined demographic information from step 320 to target specific advertisements to the new user at step 330. For example, if the new user's gender is determined, then the gender-specific advertisements may be targeted to the new user. Such advertisements may include perfume purchase discount suggestions for females or beard shaving equipment purchase discounts for males. The recommender system may have access to potential advertisements from an internal or external data base or network server, not shown.

Either or both of step 325 or 330 may be taken as useful actions taken to exploit the demographic information extracted from the ratings provided by the new user 125. Steps 315 through 330 may be repeated for each new user that utilizes the services of the recommender system 130. A user that receives an enhanced recommendation or an advertisement from the recommender system would receive the enhanced recommendation or advertisement on a display device associated with the user, such as user 125. Such user display devices are well known and include display devices associated with home television systems, stand alone televisions, personal computers, and handheld devices, such as personal digital assistants, laptops, tablets, cell phones, and web notebooks.

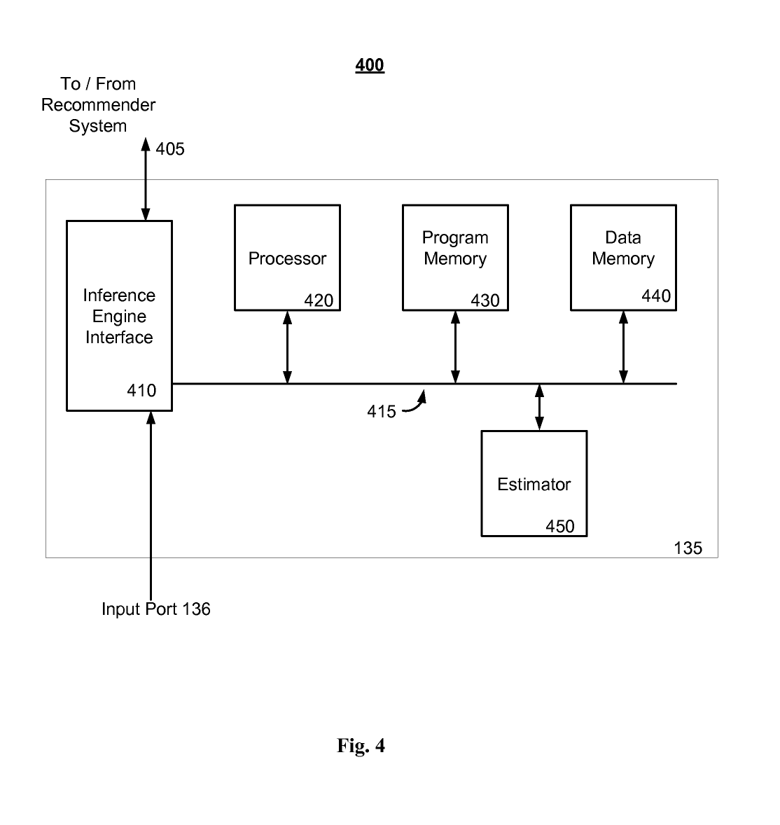

FIG. 4 is an example block diagram of an inference engine 135. The inference engine 135 interfaces with the recommender system 130 as depicted in FIG. 1. Inference engine interface 410 functions to connect the communication components of the inference engine 135 to those of the recommender system 130. The inference engine interface 410 to the recommender system at 405 may be a serial or parallel link, or an embedded or external function, as is known to those of skill in the art. Thus, the inference engine may be combined with the recommender system or may be separate from the recommender system. Interface port 405 allows the recommender system 130 to provide training data to the inference engine 135 and to provide inference results to the recommender system. An alternate training data set interface is input port 136 where training data may be input in a convenient form from a network or other digital data source such as a storage media source.

Processor 420 provides computation functions for the inference engine 135. The processor can any form of CPU or controller that utilizes communications between elements of the inference engine to control communication and computation processes for the inference engine. Those of skill in the art recognize that bus 415 provides a communication path between the various elements of inference engine 135 and that other point to point interconnections are also feasible.

Program memory 430 can provide a repository for memory related to the method 300 of FIG. 3. Data memory 440 can provide the repository for storage of information such as trains data sets, downloads, uploads, or scratchpad calculations. Those of skill in the art will recognize that memory 430 and 440 may be combined or separate and may be incorporated all or in part of processor 420. Processor 420 utilizes the storage and retrieval properties of program memory to execute instructions, such as computer instructions, to perform the steps of method 300, in order to produce demographic information for use by the recommender system 130.

Estimator 450 may be separate or part of processor 420 and functions to provide calculation resources for determination of the demographic information from a new user's ratings. As such, estimator 450 can provide computation resources for the classifier, preferably either SVM or logistic regression. The estimator can provide interim calculations to data memory 440 or processor 420 in the determination of a new user's demographic information. Such interim calculations include the probability of the demographic information related to the new user given only her rating information. The estimator 450 may be hardware, but is preferably a combination of hardware and firmware or software.

Although specific architectures are shown for the implementation of an inference engine in FIG. 4, one of skill in the art will recognize that implementation options exist such as distributed functionality of components, consolidation of components, and location in a server as a service to recommender systems. Such options are equivalent to the functionality and structure of the depicted and described arrangements.

1. A method to determine demographic information of a particular user utilizing movie ratings of the particular user, the method comprising:
receiving movie ratings of the particular user, the ratings of the particular user received having only rating information, wherein the movie ratings of the particular user contain one or more of movie identification information and a rating value;
determining, from the movie ratings of the particular user, the demographic information of the particular user, the determination made using a trained inference engine;
utilizing the determined demographic information to provide recommendations to the particular user or to provide targeted advertisements to the particular user.

2. (canceled)

3. (canceled)

4. The method of claim 1, wherein receiving ratings of the particular user comprises receiving ratings absent demographic information.

5. The method of claim 1, wherein the determined demographic information of the particular user is gender information.

6. The method of claim 1, wherein the particular user is included not in the training data set.

7. The method of claim 1, wherein the step of determining comprises determining the demographic information of the particular user using a classifier.

8. The method of claim 7, wherein the classifier is one of a support vector machine and a logistic regression algorithm.

9. An apparatus to determine demographic information of a particular user utilizing movie ratings of the particular user, the apparatus comprising:
an interface to input a training data set which includes ratings and demographic information from a plurality of other users;
a processor, having access to memory, that executes computer instructions to determine demographic information using ratings of the particular user that are absent demographic information, wherein the ratings of the particular user contain one or more of movie identification information and a rating value; and
an interface to a recommender system, the interface providing the determined demographic information to the recommender system which provides targeted advertisements to the particular user based on the determined demographic information.

10. The apparatus of claim 9, wherein the apparatus is part of the recommender system.

11. The apparatus of claim 9, wherein the interface to input a training data set also acts as the interface to the recommender system.

12. (canceled)

13. The apparatus of claim 1, wherein the determined demographic information of the particular user is gender information.

14. The apparatus of claim 1, further comprising a classifier to assist the processor in determining the demographic information of the particular user.

15. The apparatus of claim 1, wherein the classifier is one of a support vector machine and a logistic regression algorithm.

16. The method of claim 1, wherein the step of determining includes using a trained inference engine to determine demographic information using a training data set which includes ratings and demographic information from a plurality of other users.
